(19) United States
(12) Patent Application Publication
(10) Pub. No.: US 2023/0391110 A1
(43) Pub. Date: Dec. 7, 2023

(54) A PRINTING UNIT

(71) Applicant: Tetra Laval Holdings & Finance S.A., Pully (CH)

(72) Inventors: Sverker OLSSON, Södra Sandby (SE); Sylvain DEBAECKER, Eslöv (SE); Said SULEMAN, Eslöv (SE)

(21) Appl. No.: 18/250,770

(22) PCT Filed: Oct. 26, 2021
(86) PCT No.: PCT/EP2021/079701

§ 371 Date: Apr. 27, 2023

(30) Foreign Application Priority Data
Oct. 28, 2020 (EP) 20204319.6

(51) Int. Cl. B41J 11/20; B41J 15/16; B41J 11/00

(52) U.S. Cl. CPC B41J 11/20; B41F 5/24; B41J 11/0095; B41J 15/165

(57) ABSTRACT

A printing unit for use in a packaging material manufacturing system is provided. The printing unit comprises a plurality of printer rows, wherein each printer row comprises at least one printer head and a support roller for guiding the web of packaging material to be printed relative the associated at least one printer head. Said printing unit further comprises a support for the one or more support rollers and a lifting device connected to the support for moving the one or more support rollers relative the printer heads.

### TECHNICAL FIELD

The invention relates to a printing unit, and to an associated printing support. In particular, the present invention relates to a printing unit for use in high speed and high throughput production facilities for producing packaging material.

### BACKGROUND ART

Packaging containers of the single use disposable type for liquid or semi-liquid foods are often produced from a packaging material based on paperboard or carton. The packaging material of this known packaging container is typically manufactured as a laminate comprising a bulk layer of paper or paperboard and outer, liquid-tight layers of thermoplastics.

On the inside of the laminate, i.e. the side intended to face the filled food contents of a packaging container produced from the laminate, there is one or more inner layers comprising heat sealable thermoplastic polymers.

The appearance of packaging containers manufactured from the above-described packaging material is dependent on a décor printed on an outer layer of the packaging material, forming an exterior side of the packaging container. The printed décor is conventionally applied by means of high-speed flexography processes. These printing processes are designed for high-speed printing of wide substrate webs of several meters in e.g. packaging material manufacturing plants.

For every color to be printed by flexography, a printing plate is made and mounted on the circumference of a rotatable printing cylinder. For packaging material manufacturing, the printing plate contains a repeat of the pattern to be printed. The repeat length, which equals the circumference of the printing cylinder when the printing plate is mounted thereto, may typically correspond to 3-6 packaging container prints and may vary e.g. between 450 and 800 mm.

The width of the printing plate is typically selected so that a décor is printed on multiple lanes at the same time; each lane will eventually be separated and used in a packaging container manufacturing machine. Hence, the web of packaging material entering the flexography process will be provided with a repetitive printed pattern, each printed pattern being designed for a single packaging container to be produced.

In order to increase printing speed the printing plate width may correspond to twelve lanes. Consequently, as the printing plate is performing one revolution the packaging material will be provided with a printed pattern on an area corresponding to up to 12*6 packaging container to be produced.

The configuration of the printing plate is static, which means that the printed pattern will be the same for all packaging containers being produced using the same printing plate. However, during recent years it has been suggested to also provide a dynamic print on the packaging material which can be accessed by a consumer of the produced packaging containers. As one example, the dynamic print can be a two-dimensional code containing specific information.

Such dynamic prints cannot be obtained using existing flexography processes due to its repetitive character. Instead it has been suggested to provide a separate printing unit downstream the flexography processing equipment. The separate printing unit is capable of providing unique prints inline, e.g. by implementing inkjet technology, thereby allowing unique two-dimensional codes or other dynamic objects to be printed at areas of the packaging material; typically, each final packaging container will have a dynamic print.

In high-throughput production facilities the printing unit is normally comprising several parts acting together to provide the prints at the desired location and at the desired speed. Typically, the printing unit is formed by consecutive printing rows. Each printing row comprises one or more printing heads, and one printing roller for guiding the packaging material relative the printing heads. Hence, as the packaging material is transported through the printing unit it will rest onto the guiding rolls, while passing under the printing heads.

As the packaging material is running at high speed through the printing unit, service and maintenance of the printing heads will be required at regular intervals. This requires the printing heads to be arranged at a service position, where printing unit operators will be able to access crucial parts of the printer heads. During such repositioning of the printing heads, any contact between the printing head and the packaging material should be avoided in order to prevent damage of printing head components; one such component is the eyelid assembly, which acts as a seal for the printer head nozzles. During operation the distance between the packaging material and the printing heads is very small, typically in the range of 1-2 mm. Hence, the operator must be extremely careful not to damage any crucial components of the printing unit during repositioning for maintenance, but also during normal operation of the printing unit.

In view of the above there is a need for improvements of printing unit, especially for the above-described high-throughput machines, in order to avoid unnecessary damage of components.

### SUMMARY

It is an object of the invention to at least partly overcome one or more of the above-identified limitations of the prior art. In particular, it is an object to provide a printing unit which is capable of reducing the risk for damage of printing unit components due to sudden contact between the printing heads and the packaging material.

To solve these issues, a printing unit is provided. The printing unit is configured to be used in a packaging material manufacturing system and the printing unit comprises a plurality of printer rows. Each printer row comprises at least one printer head and a support roller for guiding the packaging material to be printed relative the associated at least one printer head. Said printing unit further comprises a support for the plurality of support rollers and a lifting device connected to the support for moving the plurality of support rollers relative the printer heads.

The printing unit may further comprise at least one tension roller arranged upstream and/or downstream the plurality of support rollers for urging the packaging material towards the support rollers. Hence, as the support rollers will move relative the printer heads, the we b of packaging material will remain in contact with the support rollers, thereby ensuring a controlled distance between the printer heads and the web of packaging material.

The at least one tension roller may be connected to said support. Hence, the tension roller(s) will move simultaneously, and by the same distance, as the support rollers thereby ensuring a constant tension of the web of packaging material.

The lifting device may be configured to move the plurality of support rollers away from and towards the plurality printing heads. By operating in such directions, it is possible to provide continuous control of the distance between the printer heads and the web of packaging material during operation.

The stroke of the lifting device may be between 1-10 mm, preferably between 1-mm, even more preferably between 1-3 mm. Such comparably small distance variation between the printer heads and the web of packaging material has proven to provide very reliable positioning, while still reducing the risk for damage during operation, as well as during service and maintenance.

The lifting device may be configured to move the plurality of support rollers simultaneously. Optionally, the lifting device may be configured to move each support roller by the same distance. Improved control is thereby accomplished, as each support roller will move the same distance at the same time.

The printing unit may further comprise a control unit configured to provide control signals to said lifting device for automatic control of the position of the plurality of support rollers. The control unit may thus provide in-line control of the distance between the printer heads and the web of packaging material during operation of the associated packaging material manufacturing system.

The control unit may be configured to control the plurality of support rollers to be arranged in a normal operation position, or in an increased distance position. If only two positions of the support rollers is utilized, simplified control is achieved.

The printing unit may further comprise at least one sensor configured to detect the actual thickness of the packaging material, and the control unit may further be configured to determine the increased distance position of the plurality of support rollers based on the detected packaging material thickness. Any variations of the thickness of the web of packaging material may thus be monitored in-line, and the distance between the printer heads and the web of packaging material can be automatically adjusted to compensate for any such variations. Thereby it is not only possible to minimize the risk of damaging the web of packaging material and/or the printer heads, but the printing quality is also increased as significant variations of the distance between the web of packaging material and the printer heads are avoided.

The sensor may be arranged upstream the plurality of support rollers. This allows the support rollers to perform the movement in due time, so that the correct distance between the web of packaging material and the printer heads is achieved.

The control unit may be further configured to provide control signals to said lifting device for returning the plurality of support rollers to their normal operation position. This is particularly advantageous for a web of packaging material having a substantially constant thickness, where variations only occur rarely. Hence, the normal operation position may be a default position, which is restored immediately after a thickness variation is detected and compensated for.

The control unit may further be configured to control the lifting device in order to maintain a constant distance between the plurality of printing heads and the packaging material, during operation. This allows the printing unit to compensate not only for predicted variations by a constant distance, but the printing unit may also be capable of adjusting the distance between the web of packaging material and the printer heads at precisely the desired and optimal amount.

According to a second aspect, a printing method is provided. The method comprises i) feeding a packaging material through a printing unit comprising a plurality of printer rows, wherein each printer row comprises at least one printer head and a support roller for guiding the packaging material to be printed relative the associated at least one printer head, and wherein each support roller is mounted to a common support, and ii) increasing the distance between each support roller and the at least one printer head by moving the support.

In an embodiment, the method may further comprise iii) measuring the thickness of the packaging material, wherein the increased distance is determined based on the measured packaging material thickness.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a schematic view of a packaging material manufacturing system, comprising a printing unit according to an embodiment;

FIG. 2 is a cross-sectional view of a printing unit;

FIGS. 3a and 3b are isometric views of a printer head forming part of a printing unit;

FIGS. 4a to 4c are schematic front views of a printing unit according to an embodiment;

FIGS. 5a to 5c are cross-sectional views of a web of packaging material for use with a printing unit according to an embodiment;

FIGS. 6a and 6b are schematic side views of a printing unit according to an embodiment; and

FIG. 7 is a schematic flow chart of a printing method according to an embodiment.

### DETAILED DESCRIPTION

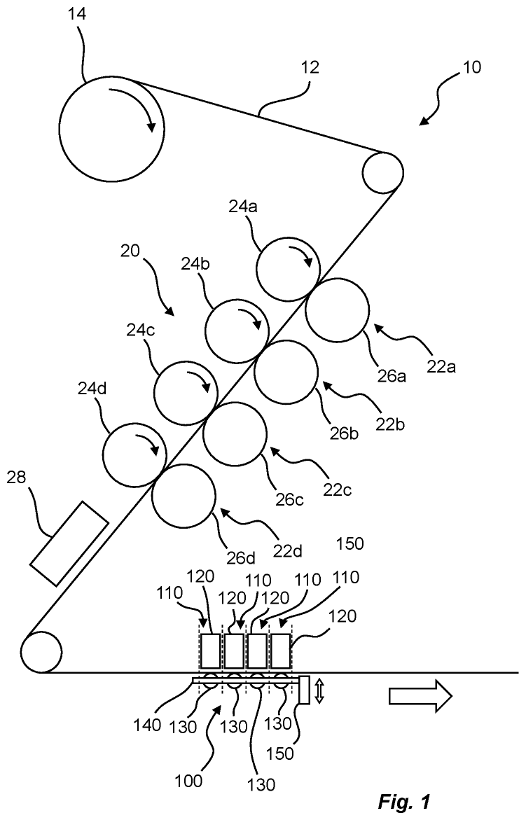

With reference to FIG. 1 a packaging material manufacturing system 10 is illustrated. The packaging material manufacturing system 10 comprises a décor printing system 20, and a printing unit 100 arranged downstream the décor printing system 20.

A web of packaging material 12 is wound on a roll 14, and fed continuously through the packaging material manufacturing system 10 in the direction of the block arrow. The web of packaging material 12 is preferably pre-manufactured as a laminate comprising a bulk layer of paper or paperboard and outer, liquid-tight layers of thermoplastics, as well one or more inner layers comprising heat sealable thermoplastic polymers.

The décor printing system 20 is preferably a flexo printing system, comprising a series of flexo printing units 22a-d. Each flexo printing unit 22a-d comprises a plate cylinder 24a-d and an impression cylinder 26a-d. The plate cylinder 24a-d and the associated impression cylinder 26a-d forms a nip through which the web of packaging material 12 is fed through, thereby transferring ink from the plate cylinder 24a-d to the web of packaging material 12. In the shown example, four flexo printing units 22a-d are shown. Each flexo printing units 22a-d is responsible for a specific color; in one example, the flexo printing units 22a-d provide each one of the CMYK color scheme. Each flexo printing unit 22a-d may comprise additional components, such as anilox rollers and fountain rollers, as is well known in the art.

The décor printing system 20 is optionally provided with a drying unit 28. The drying unit 28 is arranged downstream the flexo printing units 22a-d. The drying unit 28 may operate by providing IR radiation or hot air to the web of packaging material 12, thereby drying the ink on the web of packaging material 12.

It should be noted that the décor printing system 20 may not necessarily be a flexo printing system, but other well-known techniques may be used as well for providing a décor to the web of packaging material 12.

Once the web of packaging material 12 is provided with the décor, it is passed through the printing unit 100. As will be explained further in the following, the printing unit 100 comprises a plurality of printer rows 110. The printer rows 110 are distributed in the machine direction, i.e. along the transport path of the web of packaging material 12. Each printer row 110 has at least one printer head 120, and an associated support roller 130. During operation, the web of packaging material 12 is guided by the surface of the support roller 130 such that a correct and desired distance between the web of packaging material 12 and the printer head(s) 120 is obtained during printing.

As is schematically shown in FIG. 1, the support rollers 130 are arranged on a common support 140. The support 140 is in turn connected to a lifting device 150 which is capable of adjusting the position of the support 140, thereby also moving the plurality of support rollers 130. Moving the plurality of support rollers 130 will reduce the risk of damaging the printer heads 120, as well as the web of packaging material 12 by preventing the printer heads 120 and the web of packaging material 12 to contact each other.

During operation, the printing unit 100 is configured to provide prints to the web of packaging material 12 in a repeated manner, as well as ensuring that the prints are aligned with the décor to a level of accuracy which has not been possible before. Advantageously, the printing unit 100 is arranged in-line with the upstream décor printing system 20.

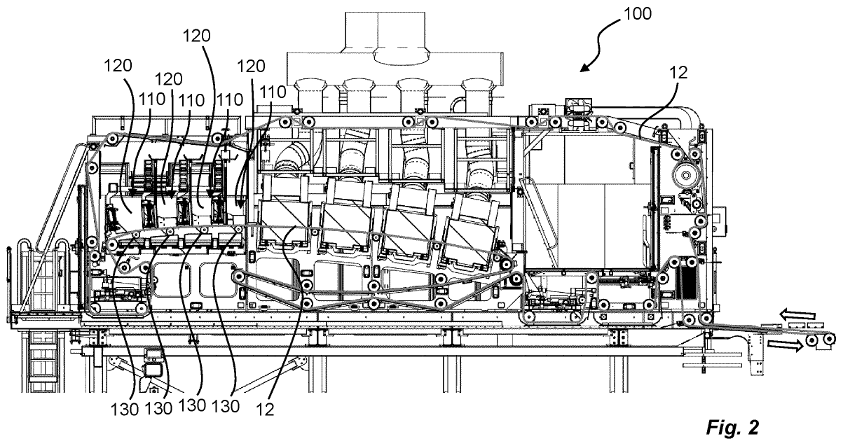

In FIG. 2 a more detailed example of a printing unit 100 is shown. The web of packaging material 12 is transported across various rollers before passing the printing heads 120. The reason for not passing the printing heads 120 immediately after entering the printing unit 100 is not only for allowing accurate control of the tension of the web of packaging material 12, but also for allowing sufficient drying of the décor applied earlier in the packaging material manufacturing process, as well as allowing additional packaging material processing such as splicing, cleaning and dust removal, etc., to be performed within the printing unit 100.

In this example, the printing unit 100 comprises four printer rows 110 arranged in series along the transport path of the web of packaging material 12. Each printing row 110 is formed by one or more printing heads 120, and an associated support roller 130. A plurality of hot air dryers 160 are arranged downstream the printing rows 110. After exiting the printing unit 100, the web of packaging material 12 is prepared for further handling such as cutting, winding, etc.

The printing unit 100 will allow for a novel and significantly improved combination of static décor printing and printing of dynamic content to a web of packaging material 12, and also for reducing damage and for improving print quality.

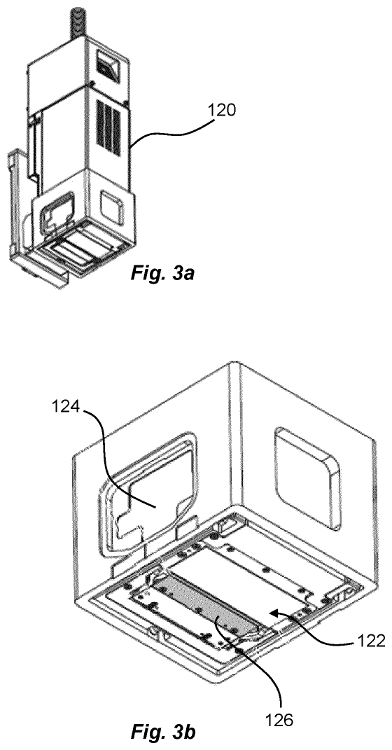

In order to fully understand the advantages of the embodiments described herein some printer unit 100 details will be briefly explained. As mentioned above, each printer row 100 is provided with one or more printer heads 120. An example of a printer head 120 is shown in FIGS. 3a and 3b. The bottom part of the printer head 120 is configured to allow droplets of ink to be ejected onto the web of packaging material 12 which during operation is running immediately below the printing head 120; the vertical distance between the web of packaging material 12 and the printing head 120 is typically a few millimeters, at most.

Turning to some more detailed facts of printing heads 120, a printing head 120 for packaging material production may be approximately 1 meter in height, 0.5 meter in width, and 0.6 meter in depth. The weight of a printing head 120 may be above 100 kg. The printing head 120 typically comprises pumps, valves, filters, etc. for controlling proper operation. Yet further, the printing head 120 may comprise a jetting module 122 which is configured to discharge the ink through a nozzle plate (not shown), and a printing head interface controller 124 for controlling the electronics, software, and fluid connections for driving the printing head 120.

In order to ensure extremely fast and robust printing operation, the bottom part of the printing head 120 is typically provided with critical components at its bottom end. For example, as is shown in FIG. 3b, a rubber seal 126 is covering the bottom part of the printing head 120 at least partly. The purpose of the rubber seal 126 is to form an open/close hatch; an open position of the rubber seal 126 is allowed when the printing head 120 is controlled to discharge ink (i.e. to print), while the seal 126 is in its closed position during idle mode, i.e. when no printing is desired.

The inventors have realized that any damage of the rubber seal 126 may cause ink to leak out from the printing head 120, onto the web of packaging material 12 or onto other equipment if no web of packaging material 12 is loaded. If the rubber seal 126 is damaged, replacement is required. The total cost for replacement of rubber seals 126 is not only the actual cost for the replacement part. In addition, it is rather time consuming why machine downtime and staff costs must be added to the complete cost.

The inventors have also realized that the main reason for damage of the printing head 120, and in particular the rubber seal 126, is because of unwanted contact between the bottom part of the printing head 120, e.g. the rubber seal 126, and the web of packaging material 12.

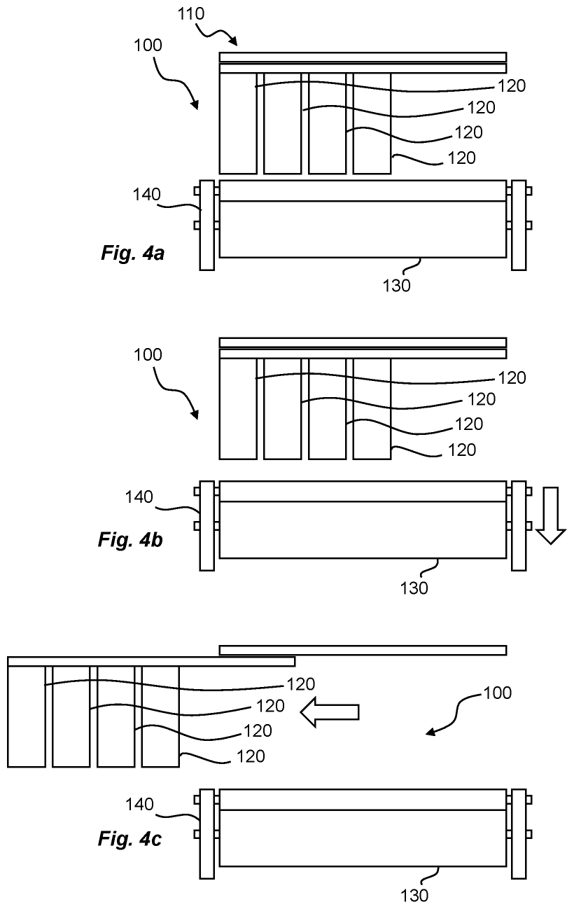

In FIGS. 4a-c one situation is illustrated where the risk for damage of the printing head 120, e.g. the rubber seal 126, is increased. At regular intervals it is required to perform service of the printing unit 100; such service and maintenance is most often performed on the printing heads 120, which for various reasons may need to be attended for cleaning, replacement of parts, refill, lubrication, etc. In FIG. 4a the printing unit 100 is shown during normal operation. Here, the front-most printing row 110 is shown. The printing row 110 has four printing heads 120 distributed across the machine width W (which typically corresponds to the width of the web of packaging material. The printing heads 120 are aligned with the associated support roller 130, which is mounted to the support 140. Although not shown in FIG. 4a, it should be noted that preferably the support rolls 130 for each printing row 110 are mounted to the same support 140.

The space around the printing heads 120 is very narrow, why they need to be moved away from the production position in order to allow access by service staff. Such position is shown in FIG. 4c, where the printing heads 120 have been moved in a transverse direction, away from the support roller 130. When in this position, an operator may easily access the printing heads 120 for service and maintenance.

However, as mentioned earlier the vertical distance between the printing heads 120 and the support roller 130 is very small; when the web of packaging material is arranged onto the support roller 130, which is normally the case when service is requested, the vertical distance between the web of packaging material and the bottom of the printing head 120 is in the range of 0.5 to 3 mm, such as between 1-2 mm. The length of the support roller 130 may at the same time be above 1,5 m; a common width of the web of packaging material is 1,66 m. Hence, to perform the printing head 120 movement indicated in FIG. 4c the printing heads 120 need to travel 1 m or more, while at the same time the printing heads 120 must not hit the web of packaging material.

Before performing the lateral movement shown in FIG. 4c, the entire support 140 is moved downwards, as indicated in FIG. 4b. The downward movement of the support 140 is preferably comparably small, such as in the range of 3-5 mm. However, creating an increased distance by 3 mm has proven to be sufficient in order to prevent any contact between the bottom end of the printing heads 120 and the web of packaging material.

When service is finished, the printing heads 120 are returned to their operational position (indicated in FIGS. 4a and 4b), whereafter the support 140 is raised to its operational position (indicated in FIG. 4a). Especially, simultaneous movement of all support rollers 130, by moving the support 140, has proven to be very efficient in terms of position control and for reducing the risk of damage to any printing head 120.

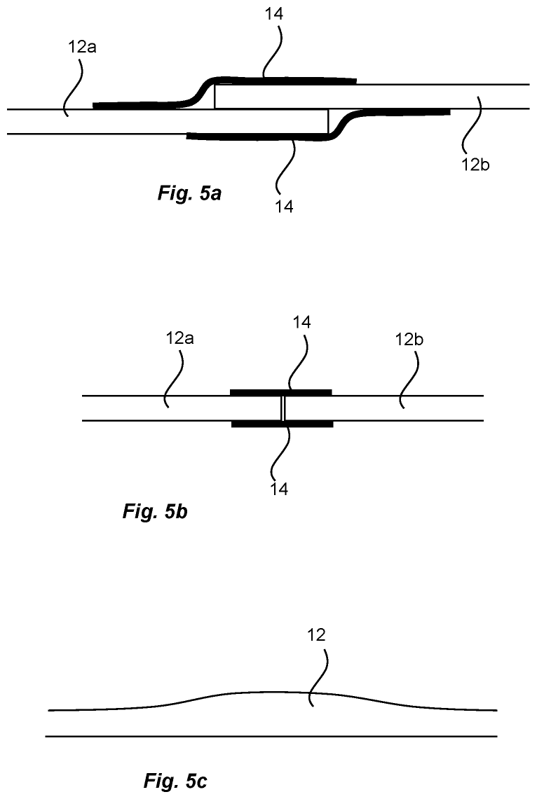

During normal operation of the packaging material manufacturing system, also involving operation of the printing unit 100, the web of packaging material 12 may not necessarily have a constant thickness. Instead, some variations of the thickness may occur at regular, or random, intervals. In FIG. 5a a first example of thickness variations is shown. Here, two webs of packaging material 12a-b are merged in an overlap configuration. Such merging, known as splicing, will cause an increased thickness at the overlap and its adjacent surroundings. Tape 14 is arranged on both sides of the web of packaging material 12a-b, whereby the maximum thickness of the web of packaging material will be two times the thickness of the individual webs of packaging material 12a-b, plus two times the thickness of the tape.

In FIG. 5b another example of a splice is shown. Here, two webs of packaging material 12a-b are arranged in an end-to-end configuration, and tape 14 is arranged on both sides in order to attach the webs of packaging material 12a-b to each other. In this example, the maximum thickness of the web of packaging material will be the thickness of an individual web of packaging material, plus two times the thickness of the tape 14.

In FIG. 5c another example of thickness variations is shown. No splice is present, but the web of packaging material 12 is instead subject to a local thickness increase. Such may be due to uneven humidity, allowing the core layer of the packaging material to swell locally, or due to local variations of the thickness of any plastic layer of the packaging material laminate.

Independently of the reason for thickness variations, the printing quality of the printing unit 100 may be reduced as the distance between the upper surface of the web of packaging material 12 and the bottom end of the printing heads 120 will vary. Normally, a printing unit 100 is optimized for a specific, and constant, distance between the bottom end of the printing heads 120 and the printing substrate, i.e. the web of packaging material 12. Yet further, a thickness increase may also cause damage of the printing head 120 and/or to the web of packaging material 12 if they would accidentally come into contact with each other.

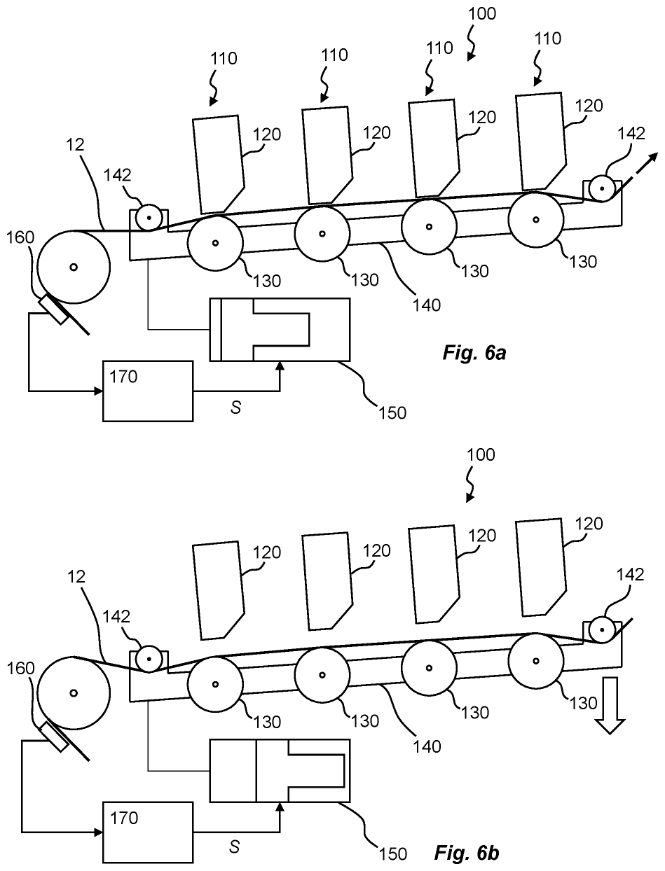

The idea of controlling the position of the support rollers 130 may be used during operation of the printing unit 100 in order to solve these disadvantages, and in particular to reduce the risk for damage and for improving printing quality. An embodiment of a printing unit 100 is shown in FIGS. 6a-b. Similar to the embodiments described above, the printing unit 100 comprises a plurality of printing rows 110. While four printing rows 110 are shown it should be noted that any suitable number of printing rows 110 may be used.

The printing rows 110 are distributed in the machine direction, i.e. in the transport direction of the web of packaging material 12 such that during operation, a specific area of the web of packaging material 12 will pass one printing row 110 at the time.

Each printing row 110 comprises at least one printing head 120 and at least one support roller 130. As mentioned earlier, a typical number of printing heads 120 used for each printing row 110 may be 2 to 14, depending on the desired lateral coverage of each printing head 120. For example, each printing head 120 may be designed to have a lateral coverage corresponding to one lane of the web of packaging material 12. If the total width of the web of packaging material 12 corresponds to e.g. 14 lanes, it may be desirable to have 14 printing heads 120 on each printing row 110. In another setup it may be desired to have seven printing heads 120 on each printing row 110, where very second printing row 110 has its printing heads 120 arranged to cover the leftmost lanes of the web of packaging material 12 while every other second printing row 110 has it sprinting heads 120 arranged to cover the rightmost lanes of the web of packaging material 12.

In a typical example, each printing head 120 is a continuous ink jet unit or a drop-on-demand inkjet unit. Each printing head 120 may be capable of printing four different colors, such as according to the CMYK color scheme. However, in other embodiments on or more printing heads 120 is capable of printing more than four different colors, such as eight different colors according to the CMYK and OVGX color schemes.

With regards to the support rollers 130, the purpose of these is to guide the web of packaging material 12 along the printing unit 100 and to provide a well-defined position of the we b of packaging material 12 as it passes underneath the respective printing heads 120. In a typical example, as indicated in FIGS. 6a and 6b, each printing row 110 has only on support roller 130. However, additional support rollers 130 may be provided for one or more printing rows 110. In a further embodiment, two or more printing rows 110 may share a common support roller 130. As one example of such embodiment, a single support roller 130 may be provided, wherein consecutive printing heads 120 are arranged along the circumference of the support roller 130. A printing row 110 for such embodiment would then correspond to one or more printing heads 120 at a specific circumferential position of the support roller 130, as well as the support roller 130.

Again returning to the embodiment shown in FIGS. 6a-b, the support rollers 130 are all mounted on a common support 140. The support 140 is also provided with two tension rollers 142 arranged on each side (in the machine direction) of the support rollers 130. Hence, one tension roller 142 is arranged upstream the support rollers 130, while the other tension roller 142 is arranged downstream the support rollers 130. The primary purpose of the tension rollers 142 is to urge the web of packaging material 12 towards the support rollers 130, and prevent the web of packaging material 12 from moving away from the circumferential surface of the support rollers 130 towards the bottom end of the printing heads 120.

A lifting device 150 is connected to the support 140 for moving the support 140, and the thereto connected support rollers 130, in a direction towards and away from the printing heads 120. The lifting device 150 is shown as a piston/cylinder device, thereby indicating the lifting device 150 to be a pneumatic or hydraulic lifting device 150. However, in some embodiments the lifting device 150 may be implemented as any other suitable mechanical device for causing a translation movement of the associated support 140; the lifting device 150 may e.g. by an electric component, such as a linear motor or similar.

In FIG. 6a the support 140 and the support rollers 130 (as well as the tension rollers 142) are in a raised position, corresponding to a minimum or optimal distance between the web of packaging material 12 and the bottom end of the printing heads 120. In FIG. 6b the lifting device 150 has caused the support 140 and the support rollers 130 to move downwards, thereby increasing the distance between the web of packaging material 12 and the bottom end of the printing heads 120. As can be seen in FIG. 6a also the tension rollers 142 have moved with the support 140; thereby the web of packaging material 12 is pressed downwards towards the circumferential surface of the support rollers 130, thus ensuring the correct position of the web of packaging material 12 and increasing the distance between the web of packaging material 12 and the bottom end of the printing heads 120.

The lowered position of the support 140, shown in FIG. 6b, is used when the printing heads 120 are to be repositioned for service and maintenance as has been described above with reference to FIGS. 4a-c. However, this lowered position can also be automatically controlled during operation in order to compensate for variations of the thickness of the web of packaging material 12.

For such configuration, one or more sensors 160 are provided. The one or more sensors 160 may be of any suitable type known in the art for determining material thicknesses; for example, optical, ultrasonic, or contact sensors may be used.

As the one or more sensors 160 detect a variation of the thickness of the web of packaging material 12, a control unit 170 is configured to determine a corresponding control signal S to the lifting device 150. The control signal S is containing information of how the lifting device 150 should be activated in order to cause a desired repositioning of the support 140. The control unit 170 may for this purpose be configured to process additional system parameters, such as e.g. the speed of the web of packaging material 12, the time required for a specific area of the web of packaging material 12 to move from the position of the one or more sensors 160 until it reaches the first support roller 130, as well as the time required for a specific area of the web of packaging material 12 to move from the position of the first support roller 130 until it leaves the last support roller 130. The control unit 170 may thus be configured to apply various parameter processing in order to provide time damping, signal amplification, etc.

In one embodiment the control unit 170 is configured to operate as follows. As soon as the one or more sensors 160 is detecting an increased thickness of the web of packaging material 12 the control unit 170 determines a control signal S which is transmitted to the lifting device 150. The control signal S may either be constructed such that the lifting device immediately is activated, causing an immediate movement of the support 140. Alternatively, the control signal S is constructed with a set time delay, whereby the lifting device 150 is instructed to be activated at a specific time.

Once the one or more sensors 160 is detecting another change of the thickness of the web of packaging material 12, e.g. if a local thickness increase is no longer present, the control unit 170 will issue a new control signal S to the lifting device 150 which hen activated is causing a return motion of the support 140 to its normal operation position. Hence, by implementing real-time monitoring of the thickness of the web of packaging material 12 by means of the one or more sensors 160 the control unit 170 can control actuation of the lifting device 150 such that the support 140 is always positioned correctly, thereby ensuring optimal distance between the web of packaging material 12 and the bottom end of the printing heads 120 and eliminating the risk for damage of the web of packaging material 12 and of the printing heads 120.

In one specific embodiment, the thickness difference caused by a packaging material splice can mechanically activate an instant lowering of the support 140 to increase the distance between the web of packaging material 12 and the printing heads 120 to allow the splice to safely pass through the printing unit 100 without damaging the printing heads 120. In such embodiment the one or more sensors 160 are arranged on a sensoring roller. The sensoring roller is connected to a mechanical balance configuration that simultaneously, at the same time the splice activates the sensoring roller, mechanically lowers the support 140. Hence the sensoring roller may be in direct communication with the lifting device 150.

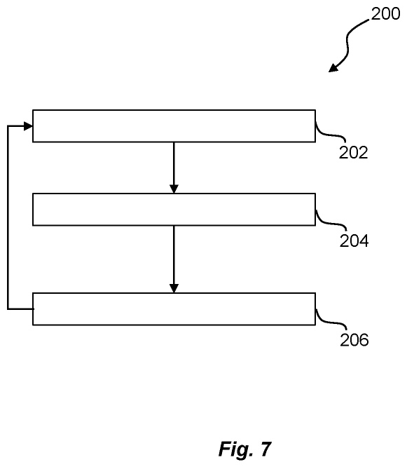

Now turning to FIG. 7, an embodiment of a printing method 200 is described. The method 200 is performed by a first step 202 of feeding a packaging material through a printing unit comprising a plurality of printer rows. Here, each printer row comprises at least one printer head and a support roller for guiding the packaging material to be printed relative the associated at least one printer head, and each support roller is mounted to a common support. A further step 204 is performed by increasing the distance between each support roller and the at least one printer head by moving the support.

The method may further comprise a step 206 of measuring the thickness of the packaging material, wherein the increased distance is determined based on the measured packaging material thickness.

Preferably, the method 200 is performed continuously during operation of the printing unit such that the correct distance between the web of packaging material 12 and the bottom end of the printing heads 120 is always maintained, also when a local thickness increase of the web of packaging material 12 is present. Further, the method 200 may be initiated on-demand, e.g. when service and maintenance of the printing heads 120 is required.

From the description above follows that, although various embodiments of the invention have been described and shown, the invention is not restricted thereto, but may also be embodied in other ways within the scope of the subject-matter defined in the following claims.

1. A printing unit for use in a packaging material manufacturing system, comprising a plurality of printer rows wherein each printer row comprises at least one printer head and a support roller for guiding the web of packaging material to be printed relative the associated at least one printer head,
wherein said printing unit further comprises a support for the one or more support rollers and a lifting device connected to the support for moving the one or more support rollers relative the printer heads.

2. The printing unit according to claim 1, further comprising at least one tension roller arranged upstream and/or downstream the one or more support rollers for urging the web of packaging material towards the support rollers.

3. The printing unit according to claim 2, wherein the at least one tension roller is connected to said support.

4. The printing unit according to claim 1, wherein the lifting device is configured to move the one or more support rollers away from and towards the plurality printing heads.

5. The printing unit according to claim 4, wherein the stroke of the lifting device is between 1-10 mm, preferably between 1-5 mm, even more preferably between 1-3 mm.

6. The printing unit according to claim 1, wherein the lifting device is configured to move the one or more support rollers simultaneously.

7. The printing unit according to claim 1, wherein the lifting device is configured to move each support roller by the same distance.

8. The printing unit according to claim 1, further comprising a control unit configured to provide control signals to said lifting device for automatic control of the position of the one or more support rollers.

9. The printing unit according to claim 8, wherein the control unit is configured to control the one or more support rollers to be arranged in a normal operation position, or in an increased distance position.

10. The printing unit according to claim 9, further comprising at least one sensor configured to detect the actual thickness of the web of packaging material, and wherein the control unit is further configured to determine the increased distance position of the one or more support rollers based on the detected packaging material thickness.

11. The printing unit according to claim 10, wherein the sensor is arranged upstream the one or more support rollers.

12. The printing unit according to claim 9, wherein the control unit is further configured to provide control signals to said lifting device for returning the one or more support rollers to their normal operation position.

13. The printing unit according to claim 9, wherein the control unit is further configured to control the lifting device in order to maintain a constant distance between the plurality of printing heads and the web of packaging material, during operation.

14. A printing method, comprising:
feeding a packaging material through a printing unit comprising a plurality of printer rows, wherein each printer row comprises at least one printer head and a support roller for guiding the packaging material to be printed relative the associated at least one printer head, and wherein each support roller is mounted to a common support, and
increasing the distance between each support roller and the at least one printer head by moving the support.

15. The printing method of claim 14, further comprising measuring the thickness of the packaging material, wherein the increased distance is determined based on the measured packaging material thickness.
